(19) United States
(12) Patent Application Publication
(10) Pub. No.: US 2009/0326897 A1
(43) Pub. Date: Dec. 31, 2009

(54) METHOD FOR DETERMINING THE BEHAVIOR OF A BIOLOGICAL SYSTEM AFTER A REVERSIBLE PERTURBATION

(75) Inventors: Andreas Schuppert, Kurten (DE); Heidrun Ellinger-Ziegelbauer, Haan (DE); Hans-Jürgen Ahr, Wuppertal (DE)

Correspondence Address: Anscomb, Brian C., 875 Third Avenue, 8th Floor, New York, NY, 10022, US

(73) Assignee: BAYER TECHNOLOGY SERVICES GMBH, Leverkusen (DE)

(21) Appl. No.: 12/307,987

(22) PCT Filed: Jun. 28, 2007
(86) PCT No.: PCT/EP07/05712

§ 371 Date: Feb. 5, 2009

(30) Foreign Application Priority Data
Jul. 11, 2006 (DE) 10 2006 031 979.6

(51) Int. Cl. G06G 7/60; G06F 19/00; G06F 17/18

(52) U.S. Cl. 703/11; 702/19; 702/179

(57) ABSTRACT

The invention relates to a method for determining the behavior of at least one biological system after a reversible perturbation, comprising the following steps:
(a) providing at least one biological system, the biological system comprising a biological network comprising a multiplicity of biological or biochemical components, which have an activity;
(b) providing a linear model for describing the behavior of the network of the biological system;
(c) determining the activity of the biological or biochemical components of the biological network;
(d) reversibly perturbing the activity of at least one of the biological or biochemical components, a reaction of the biological network being generated which is formed by the change in the activity of at least one or more of the biological or biochemical components;
(e) determining the activity of the biological or biochemical components of the biological network after exerting the reversible perturbation, as soon as the components of the network have completed the reaction to the perturbation;
(f) determining the change in the activity of at least one biological or biochemical component of the biological network as a reaction to the reversible perturbation;
(g) calculating the behavior of the biological network with the aid of the linear model provided for describing the behavior of the biological network and the change in the activity of the biological or biochemical component(s) of the biological network after the reversible perturbation as determined in step (f), while taking into account the biodiversity of the reaction of the biological or biochemical component(s); and
(h) optionally comparison between the change in the activity of the individual components as determined according to step (f) and the behavior of the biological network as calculated according to step (g) with the aid of the linear model which is provided, there being expected to be a match of the calculated behavior with the change in the activity of the biological or biochemical component(s) as determined in step (f).

The invention relates to a method for determining the behavior of at least one biological system after a reversible perturbation.

Eukaryotic and prokaryotic cells, which are exposed to an external stress, show significant changes in the expression of more or less large groups of genes; up to 30% of all the genes may be affected. It may be inferred from this that a change in the gene expression as a response to an external stress does not represent a local phenomenon in a network of mutually regulating genes, and also that the stress response is not restricted to isolated genes, molecules or signal paths, even if the causal mode of action of the stress should affect only a few genes. There is evidently a mutual influence and high data exchange between various signal paths, which allows a cell to extend the cellular stress response from its local action to large parts of the gene expression.

The general action on a toxic stress at the protein level has been studied for example for a protein-protein interaction network in S. cerevisae and E. coli bacteria, in which case it has been possible to show that a toxic stress causes a stress response of large groups of proteins.

It is assumed that the organization structure of the stress response may be described in the form of very complexly interacting hierarchies, which in turn are based on local interactions in the overall network which can be interpreted as biological signal paths and comprehensive functional modules. The biological regulation of a stress can therefore have comprehensive effects on the activity of cellular networks and involve exchange between various signal paths and functional units.

Global modulation of the gene expression suggests that an integrated approach based on generic properties of extended mechanisms of the stress response in networks might be suitable for describing such a stress response.

Methods for determining such a stress response are known in the prior art. For example, document WO 03/077062 and “Gardner et al., Science, Vol. 301 (5629), pp. 102-5 (4 Jul. 2003)” discloses a model for describing a stress-induced change in gene expression by using a group of differential equations, which represent the activity of the individual elements of the network by variables. A disadvantage with this method is however that the matrix quantifying the equations, which describes the interactions of the individual elements, must be calculated explicitly. A prerequisite for explicit calculation of the interaction of individual elements is that the interaction of the individual elements should be known. For genes, for example, this is sufficiently known in very few cases. Such a calculation then involves the interaction of the individual components having to be found experimentally using exactly defined perturbations. Explicit calculation with this model is therefore not possible for a sizeable number of elements, and the describable network is limited to a very small number of elements and their interactions.

It was therefore an object of the invention to provide a model for describing changes in the gene expression as a response to an external stress, which overcomes said disadvantages of the prior art. In particular, it was an object of the present invention to provide a method which makes it possible to determine a stress response in networks without the explicit interaction of the elements having to be known.

According to the invention, the object is achieved by providing a method for determining the behavior of at least one biological system after a reversible perturbation, which comprises the following steps:
(a) providing at least one biological system, the biological system comprising a biological network comprising a multiplicity of biological or biochemical components, which have an activity;
(b) providing a linear model for describing the behavior of the network of the biological system;
(c) determining the activity of the biological or biochemical components of the biological network;
(d) reversibly perturbing the activity of at least one of the biological or biochemical components, a reaction of the biological network being generated which is formed by the change in the activity of at least one or more of the biological or biochemical components;
(e) determining the activity of the biological or biochemical components of the biological network after exerting the reversible perturbation, as soon as the components of the network have completed the reaction to the perturbation;
(f) determining the change in the activity of at least one biological or biochemical component of the biological network as a reaction to the reversible perturbation;
(g) calculating the behavior of the biological network with the aid of the linear model provided for describing the behavior of the biological network and the change in the activity of the biological or biochemical component(s) of the biological network after the reversible perturbation as determined in step (f), while taking into account the biodiversity of the reaction of the biological or biochemical component(s); and
(h) optionally comparison between the change in the activity of the individual components as determined according to step (f) and the behavior of the biological network as calculated according to step (g) with the aid of the linear model which is provided, there being expected to be a match of the calculated behavior with the change in the activity of the biological or biochemical component(s) as determined in step (f).

Further subjects of the present invention relate to a computer program product, a computer program and a computer system for carrying out one or more steps of the method according to the invention.

Other advantageous configurations of the invention may be found in the dependent claims.

The term “biological system” in the sense of the present invention is intended to mean a cell or a cell population, for example a tissue or an organ such as the liver, or a multicellular organism, in particular a mammal such as a mouse or rat. In preferred embodiments, the biological system is selected from the group comprising cell(s), tissue, organ(s) and/or organisms.

A biological system contains a multiplicity of biological or biochemical components. The term “biological component” in the sense of the present invention is intended to mean biological cellular constituents of various types, for example genes, which are mutually connected and/or can affect one another. It is to be understood that the type of biological component depends on the type of biological system considered. If the biological system considered is a cell, then the biological components are selected from the group of cellular constituents, in particular genes. If the biological system considered is a cell population such as a tissue or organ, then the biological components may be genes and also individual cells.

The term “biochemical component” in the sense of the present invention is intended to mean biochemical cellular constituents of various types, in particular molecules, which are mutually connected and/or can affect one another. In preferred embodiments, the biological component is selected from the group comprising molecules contained in the cell or cell populations, such as deoxyribonucleic acid (DNA), ribonucleic acid (RNA), proteins and/or metabolites.

The term “activity” in the sense of the present invention is intended to mean that a biological or biochemical component has a property or function. For example, genes or proteins are either expressed or not expressed, or have an expression rate which can be determined, for example, as an RNA or gene product content. Genes or proteins may furthermore be present in a particular quantity or concentration and exert functions, for example catalytic actions which can be varied by chemical modification of the gene or protein. An activity or the state of an activity may correspond to the amount, concentration, expression rate or catalytic function. A chemical modification or functionalization of a component, for example a gene or protein, may correspond to an activity state, although in the scope of the invention a chemical modification or functionalization may also define two different biological or biochemical components.

The term “biological network” in the sense of the present invention is intended to mean a group or multiplicity of biological or biochemical components, which may influence one another and/or have effects on the activity of other components. A biological network preferably contains biological or biochemical components of one type, although a biological network may also contain biological and/or biochemical components of different types, which can influence one another. For example, a biological network may comprise genes, RNA molecules, proteins and/or metabolites which can mutually influence one another in their respective activity.

The term “reversible perturbation” in the sense of the present invention is intended to mean that the biological or biochemical components, the biological network and/or the biological system can be influenced, in which case a perturbation may in particular be a stress which acts on the system. In particular, the stress may be an external stress which acts on the system from the outside. A stress is preferably selected from the group comprising toxic stresses, preferentially selected from the group comprising stress due to non-genotoxic or genotoxic hepatocarcinogens, stress due to application of a pharmaceutical active agent, heat stress or hunger. A stress, which causes a perturbation of the system, may likewise be an active agent and/or a medicament which is added to the system. A perturbation or stress is reversible when the system returns into its initial state after the perturbation or the stress is removed.

In the sense of the invention, a perturbation causes a “reaction” of the biological or biochemical components. The term “reaction” in the sense of the present invention is intended to mean that the activity of at least one of the biological or biochemical components is modified by the perturbation. For example, the activity of at least one biological or biochemical component may be changed by the perturbation. This change of the at least one biological or biochemical component may in turn influence the activity of at least one other biological or biochemical component. A perturbation may cause a reaction of one, several or a multiplicity of the biological or biochemical components by directly or indirectly influencing the biological or biochemical components of a biological system. This reaction of the components forms the reaction of the network, which is formed according to the reaction of at least one, several or many of the biological or biochemical components.

For example, an active agent may only influence the activity of a protein or increase the concentration of a metabolite. A toxic stress may for example influence many different genes directly and indirectly in their activity, and cause an extended stress response.

The term “behavior of the biological network” in the sense of the present invention is intended to mean that the biological network reacts to the change in the activity of at least one of the biological or biochemical components, in that the mutual influence of the components has effects on the activity of other components and the network overall changes its activity by the reactions of the individual components. For example a gene may change its expression as a reaction to a stress, the expression change of this gene influencing the expression of one or more other genes which may likewise cause expression changes among one another or in further genes. As a consequence of this, the network of genes corresponding with one another overall experiences a change or shift in expression.

The term “noise” in the sense of the present invention is intended to mean that the reaction of the biological or chemical components to an identical external perturbation or stress need not be identical but, particularly in biological systems, may exhibit a variation. This variation may for example cause gradual differences in the change in the expression of a gene or protein due to an identical stress factor under identical conditions. This variation or “noise” of the reaction of the biological or biochemical components comprises a noise contribution which is based on measurement noise and measurement errors, such as regularly occur in experiments, and a biological contribution which is referred to as “biodiversity” in the sense of the present invention. Noise may, in particular, be a fluctuation in the gene or protein expression. The “noise” of the gene and protein expression due to biodiversity is described, for example, in Bar-Even et al., Nature Genetics, Vol. 38, No. 6, pp. 636-643, 2006, to which reference is made.

The term “biodiversity” in the sense of the present invention is intended to mean biological variations. Biodiversity may be biological variations selected from the group comprising natural variations of an activity of a component or of a network, natural variations of a biological system and/or variations of the biological reactions of a system to environmental factors. For example, the term “biodiversity” in the biological system of a cell or a tissue comprising a network of many individual genes may comprise a natural variation in the gene expression of an individual gene, several genes and/or a network of genes, or a natural variation in the protein expression of an individual protein, several proteins and/or a network of proteins in a protein network. A “biodiversity” in a comparison of different biological systems, for example different organisms of a species, may comprise variations selected from the group comprising a variation of the genotype, a variation of individual organs and/or a different reaction of the organism to external influences such as nutrition. It is to be understood that the biodiversity influences the activity or reactions of the components, networks and/or systems among one another, so that the biodiversity of the reaction of the components to a perturbation both may be due to the natural variation in the activity of the components and may comprise a natural variation of a biological system and/or a variation in the biological reactions of a system to environmental factors.

The term “biomarker” is used as an indirect observation method for a large number of intra- and extracellular events as well as physiological changes of an organism, which cannot be observed directly or can be observed directly only with great outlay. This may for example include the content or production rate of signal molecules, transcription factors, metabolites, gene transcripts or modifications of proteins after translation, or the physiological state of a biological system. The term “biomarker” in the sense of the present invention is intended to mean in particular a combination of a gene or gene product, a protein, or a group of genes, gene products or proteins, which is regulated up or down after a perturbation compared to the activity before the perturbation, and a corresponding calculation method for calculating quantities which are not directly observable. In particular a biological or biochemical component or a group thereof, a gene or a group of genes, which reacts specifically enough to a special perturbation is essential for a biomarker, so that it can be used alone or in combination with other genes or gene products to allow classification of perturbations in classes, for example in toxicity classes. In particular a biomarker is a combination of a biological or biochemical component or a group thereof, a gene, a group of genes or a gene product, which is characteristic of a reaction of a biological system to a particular perturbation, and an associated calculation method.

The perturbation of the basic state of the activity forms the basis of diseases which are connected with a reaction of the components or of the system to the perturbation. The present invention is based in particular on the hypothesis that perturbations may be involved in for example toxic phenomena and that biomarker, i.e. one or more components which exhibit an activity change characteristic of the reaction of the system, could form effective markers of the toxicity.

An advantage of the present invention is that because the calculation is carried out within the linear model provided for describing the behavior of a biological network while taking into account the biodiversity of the reaction of the biological or biochemical components, the behavior of the biological network can be calculated without the interaction of all components having to be calculated explicitly. A particular advantage in this case is that the behavior of the network can be reconstructed from determinable or measurable data of the individual reactions of the components. Advantageously, the behavior of the network can be attributed to the reactions of the components to the perturbation and therefore observable quantities.

In particular, a great advantage is that taking into account the biodiversity-generated variation of the reaction of the biological or biochemical components in the linear model which is provided makes it possible to determine the behavior of the network without systematic experiments.

Biological networks can be represented mathematically. The linear model provided in the scope of the method according to the invention for describing the behavior of the biological network comprises a mathematical description of the reactions of biological or biochemical components of a network to a reversible perturbation. A reversible perturbation, for which the system returns into its initial state again when the stress is removed, perturbs the activity of the components and leads to an activity change of the components affected by the perturbation. Such a change in the activity of a component may in turn exhibit an effect on the activity of other biological or biochemical components. Biological and/or biochemical components, which are components of a biological network, can interact with one another and regulate one another in their activity. The regulation may be positive or negative, for example regulating the gene expression up or down in the event that the components are genes, or regulating the protein expression up or down in the event that the components are proteins. A reversible perturbation of the activity of at least one biological or biochemical component therefore generates a reaction of the components of the biological network, which overall form the reaction of the overall network of the components.

The interaction of the individual components in a network with one another is not necessarily homogeneous. Single-value parameters cannot therefore describe the interaction of the components, and a generic formulation for calculating the behavior of a biological network is preferably suitable in the sense of this invention.

A preferred generic description may be offered by the linear model provided for describing the behavior of the biological network according to the following Equation (I):

x=Au (I)

where
x: [x₁ . . . xₙ] is a vector, which comprises determination of the change in the activity of at least one biological or biochemical component of the biological network as a reaction to the reversible perturbation,
u: [u₁ . . . uₙ] is a vector, which describes the perturbation,
A: [a₁₁, a₁₂, . . . , aₙₙ] is a matrix, which contains parameters that describe the reaction of the components to the perturbation,
n is the number of components.

The matrix is preferably described by a symmetric n×n matrix, where n corresponds to the number of components. These contain the constituents aᵢⱼ, which quantitatively describe the reaction of a component i to a stress uⱼ that acts on the component j. The matrix A thus reflects both the reaction of the components of the network to the reversible perturbation and the distribution of the reaction to a local perturbation or a local stress, which only acts on only a few components, over the entire network.

The vector x, which indicates the change in the activity of the individual components, suitably reflects data or measurement values which describe the change in the activity of the components after a reversible perturbation, after the components of the network have reacted to the perturbation.

The components react within different time spans to the perturbation by a change in their activity, depending on the type of the component, for example genes and/or proteins, and depending on the reversible perturbation exerted, in which case the time spans of a reversible reaction of the components may lie in the range of minutes, hours or days. These time spans are known to the person skilled in the art and/or can be determined. Preferably, fast reactions of the components are determined in step (f), for example changes in the gene expression which preferably occur in the range of from 0.5 hours to 24 hours after the exertion of a reversible perturbation.

The size of the matrix A depends on the number of biological or biochemical components of the network. This number may vary within wide ranges in biological networks and/or systems. If the biological system is for example a cell and the components are genes, a network may contain several thousand genes. The size of such a network may likewise be dependent on the perturbation which acts on the system. If such a perturbation is for example a toxic stress, several thousand genes may be affected by such a stress.

The number of components n may lie in the range of from ≧1 component to ≦25,000 components. Preferably the number of components n lies in the range of from ≧1 component to ≦15,000 components, preferentially in the range of from ≧1 component to ≦5000 components, particularly preferentially in the range of from ≧2 components to ≦1000 components, more preferably in the range of from ≧5 components to ≦400 components, even more preferably in the range of from ≧5 components to ≦200 components.

In preferred embodiments of the method according to the invention, the properties of the matrix A are described from the determinable change in the activity of the biological or biochemical components of the biological network after a reversible perturbation while taking into account the biodiversity of the reaction of the components. Such a calculation is preferably carried out by the vector u, which describes the perturbation that acts on the components, having a noise contribution which reflects the measurement noise, which may for example be due to measurement inaccuracies and/or measurement errors, and a noise contribution which reflects the noise due to the biodiversity of the reaction of the components, the biodiversity of this reaction reflecting the biological variation in the reaction of the components.

The linear model provided for describing the behavior of the network, comprising the matrix A, is a linear approximation of a nonlinear system. Such a linear approximation of the behavior of the network is equivalent in a fundamentally nonlinear system whenever the system is in or close to a steady state. If the biological system is for example a cell, a cell culture or an organism, for example a rat, this means that the cells or organisms are preferably to be kept in a constant environment.

In the scope of this method according to the invention, a reversible perturbation will furthermore preferentially exert a reversible stress on the system, the system returning into the initial state after the perturbation or the stress is removed. Such a reversible perturbation correspondingly makes it possible to apply a linear model for describing the behavior of the network. The return of the system into the initial state regularly comprises so-called noise, which is to be interpreted in the sense of the present invention in that the reaction of the biological or biochemical components to an identical perturbation or stress need not be identical, rather it may comprise a variation. This variation means that the components may reach the initial state or may approximate the initial state, the state adopted by the system or the individual components after the perturbation corresponding to their initial state on which the noise is superimposed.

This noise or variation in the reactions of the biological or biochemical components and/or the biological system may be divided into a noise contribution which is based on measurement noise and/or measurement errors, and a biological noise contribution which is based on the biological variation of the components and/or the system and is referred to as biodiversity in the sense of the present invention.

If the component is for example a gene and the biological system is a tissue or a cell, to which a stress is applied, the effect of the noise is that the expression of a gene after it has changed as a reaction to the reversible perturbation need not exactly readopt its initial value after the end of the perturbation, but may vary around the initial value. Even with one or more repetitions for example in at least one identical system and/or with at least one identical perturbation or stress, the component of the system will, after a reversible perturbation, return to the initial state or adopt a state which has a variation or spread around the initial state.

A prerequisite for applying the model for predicting the behavior of the network is that the system should be in a steady state. The effect of exerting a reversible perturbation or a reversible stress is that, after the perturbation or the stress is removed, the system returns into this initial steady state to within deviations produced by the biodiversity.

According to the method according to the invention, the activity of the biological or biochemical components of the biological network in the initial state is determined in step (c), the activity of at least one of the biological or biochemical components is perturbed reversibly according to step (d), a reaction of the biological network being generated which is formed by the change in the activity of at least one or more of the biological or biochemical components, and the activity of the biological or biochemical components of the biological network after exerting the reversible perturbation is determined according to step (e) as soon as the components of the network have completed the reaction to the perturbation.

Advantageously, repetition of the method according to the invention for predicting the behavior of the network is not necessary. A particular advantage of the method is that a calculation is made possible by a measurement after a perturbation in a system, wherein the initial state of the system is known or determined.

Taking into account the biodiversity of the reaction of the biological or biochemical components, the vector u which describes the perturbation acting on each component comprises a contribution which reflects the measurement noise, and a component which reflects the biological variation or biodiversity. If the contribution of the measurement noise is regarded as a constant factor, the reaction to a perturbation can be assumed as restricted to the biodiversity. It may furthermore be assumed that the biodiversity, or the biological contribution of the noise, has an energetic equidistribution and has an equidistribution in relation to the individual parameters u₁ to uₙ. The individual parameters u₁ to uₙ will also be referred to as excitation modes.

In preferred embodiments, the matrix is described by a projection of the data of the change in the determined activity of the components onto its eigenvectors with the aid of the correlation coefficients of component pairs of the biological network.

The eigenvectors of the matrix A formally describe component groups of the network, which behave coherently in their reaction to a perturbation or stress. The associated eigenvalue describes the sensitivity of the respective component group to a perturbation or stress with a coherent reaction behavior.

The correlation coefficients of the component pairs of the biological network can be determined in the form of the eigenvalues and eigenvectors of the matrix A. The eigenvalues may be obtained from the biodiversity of the reaction of the components, with the assumption that the biodiversity corresponds to a thermal noise. With this prerequisite the reaction behavior of the network, or respectively the relevant eigenvectors of the matrix A, can be calculated from an analysis of the noise behavior.

Let the matrix A preferably be an elastic matrix. Here, let {λᵢ*} be the set of the eigenvalues of A and let {φᵢ} be the corresponding orthonormalized eigenvectors.

The stiffness of the network can then be expressed by the inverse eigenvalues:

1/λᵢ*=: λᵢ

so that λᵢ describes the stiffness of the system response in the direction of the i^{th} eigenvector under a perturbation or stress.

With Equation (I), x can be represented by projections onto the eigenvectors of A according to Equation (S2):

$$x = {\sum }_{k} \frac{1}{{λ}_{k}} {ϕ}_{k} < u , {ϕ}_{k} > \qquad ( S 2 )$$

where <u, φₖ> is the scalar product between two vectors.

Furthermore let {ωₖ} be a perturbation of the system with the structure of white noise around the steady state, where k is the index of the data sets and the dimension of (ωₖ)=n.

Then, without restriction of generality, let:

<|ω|>=1

ωₖ and ωₗ are uncorrelated: <<ωₖ, ωₗ>>_{data sets}=δ_{k,l}

where ωₗ has the meaning of the perturbation of the system in the direction of the l^{th} eigenvector; the perturbation effects in the direction of the eigenvectors of the system being uncorrelated, so that the expression <<ωₖ, ωₗ>> is 0 when k is not equal to l.

With these assumptions, the excursion ηᵢ^{k} as a projection to the state onto the i^{th} eigenvector of A of the perturbation of x by ωₖ induced by the noise, corresponding to the average amplitude of the noise-induced excursion of the system in the direction of the i^{th} eigenvector, obeys the conditions presented below.

According to the assumptions of thermodynamics, the strain energy induced by white noise in an elastic network is distributed uniformly over all the eigenvectors, so that the following Equations (S3a) and (S3b) apply for the expectation values of the moments of the amplitudes:

$$\begin{matrix}< {η}_{i} {>}_{T} = 0 & ( S 3 a ) \\ < {\vert {η}_{i} \vert}^{2} {>}_{T} = \frac{{\vert ω \vert}^{2}}{Z} {\int }_{ }^{ } {\vert {η}_{i} \vert}^{2} exp ( - \frac{1}{2} {λ}_{i} {\vert {η}_{i} \vert}^{2} ) d \vert {η}_{i} \vert = μ \frac{{\vert ω \vert}^{2}}{{λ}_{i}} & ( S 3 b )\end{matrix}$$

with Z as the state sum according to the following Equation (S4):

$$Z = \int exp ( - \frac{1}{2} {λ}_{i} {\vert {η}_{i} \vert}^{2} ) d \vert {η}_{i} \vert \qquad ( S 4 )$$

and <|ηᵢ|²>_{T} as the average value over or all data sets available from the systems provided, for example a number of tissues provided.

From these equations for the amplitude distribution (S3a) and (S3b), the statistics for the noise-induced excursions ξᵢ in the original coordinates around the steady state can be calculated by projecting the amplitude statistics onto the eigenvectors according to the following Equations (S5a) and (S5b):

$$\begin{matrix}< {ξ}_{i}^{2} {>}_{T} = μ {\sum }_{k} \frac{1}{{λ}_{k}} {( {ϕ}_{k}^{i} )}^{2} & ( S 5 a ) \\ < {ξ}_{i} , {ξ}_{j} {>}_{T} = μ {\sum }_{k} \frac{1}{{λ}_{k}} {ϕ}_{k}^{i} {ϕ}_{k}^{j} & ( S 5 b )\end{matrix}$$

with φₖⁱ as the i^{th} component of the k^{th} eigenvector. Here <ξᵢ, ξⱼ>_{T} again mean the average value, formed over all the data sets available from the systems provided, for example a number of tissues provided.

A relationship according to the following Equation (S6) is obtained:

<ξᵢ,ξⱼ>_{T}=|ξᵢ∥ξⱼ|cor_{T}(ξᵢ,ξⱼ) (S6)

with cor_{T} (ξᵢ, ξᵤ) as the correlation coefficients of ξᵢ and ξⱼ on the data sets for the components i and j, and

|ξᵢ|(<ξᵢ²>_{T})^{1/2}=σ_{T}(ξᵢ)=:σᵢ

as the length of the vector ξᵢ on the data set of the component i.

A projection of the stress vector u={u₁, . . . ,uₙ} onto the eigenvectors of A:

$$u = {\sum }_{k} {ω}_{k} {ϕ}_{k}$$

$${ω}_{j} = {\sum }_{i} {u}_{i} {ϕ}_{j}^{i}$$

and substitution into Equation (S2) and interchanging the summation gives the following Equation (S7) for the excursion of xᵢ, induced by an external perturbation or stress:

$$\begin{matrix}{x}_{i} = {\sum }_{k} \frac{1}{{λ}_{k}} {ϕ}_{k}^{i} < u , {ϕ}_{k} > \\ = {\sum }_{k} \frac{1}{{λ}_{k}} {ϕ}_{k}^{i} {\sum }_{j} {u}_{j} {ϕ}_{k}^{j} \\ = {\sum }_{j} {u}_{j} {\sum }_{k} \frac{1}{{λ}_{k}} {ϕ}_{k}^{i} {ϕ}_{k }^{i} .\end{matrix} \qquad ( S 7 )$$

Substituting Equation (S5) into Equation (S7) and using the correlation of the noise-induced excursions around the steady state, represented by Equation (S6), leads to the following Equation (S8):

$$\begin{matrix}{x}_{i} = {\sum }_{j} \frac{1}{μ} {u}_{j} < {ξ}_{i} , {ξ}_{j} {>}_{T} \\ = \frac{1}{μ} \vert {ξ}_{i} \vert {\sum }_{j} {u}_{j} \vert {ξ}_{j} \vert {cor}_{T} ( {ξ}_{i} , {ξ}_{j} ) .\end{matrix} \qquad ( S 8 )$$

Now formally let:

$${ξ}_{u} = : {\sum }_{j} {u}_{j} {ξ}_{j}$$

be the weighted sum over the ξⱼ, the weights ξⱼ being the perturbation components of the j^{th} component of the system. ξᵤ is a vector with a length which is equal to the number of systems provided, for example tissue samples, and describes the effective perturbation or the effective stress on each system, for example a tissue sample, and depends only on the components i.

By using ξᵤ the analysis is simplified into the following Equation (S9):

$${x}_{i} = \frac{1}{μ} \vert {ξ}_{i} \vert {\sum }_{j} {u}_{j} \vert {ξ}_{j} \vert {cor}_{T} ( {ξ}_{i} , {ξ}_{j} ) = \frac{1}{μ} \vert {ξ}_{i} \vert \vert {ξ}_{u} \vert {cor}_{T} ( {ξ}_{i} , {ξ}_{u} ) . \qquad ( S 9 )$$

This, because |ξᵢ|=σᵢ, leads to the following proportionality relation (S10):

$$\frac{{x}_{i}}{{σ}_{i}} \text{\textasciitilde} {cor}_{T} ( {ξ}_{i} , {ξ}_{u} ) \qquad ( S 10 )$$

with the “effective stress vector” ξᵤ, which is independent of the component i and must be identified from the data of the activities of the components.

The constant of proportionality in Equation (S10) corresponds to the term |u|σᵤ of Equations (IV) to (VI) and a value ξᵤ^{j} for each data set j can be calculated by means of solving a linear equation system.

The calculation may preferably be carried out in the scope of a parameter estimation. It is possible to determine data of the activity of the components, for example the expression values for all genes in the system, for example a tissue or a sample of the tissue being studied, in the steady states. The number of data sets available for the parameter estimation is therefore equal to the number of components times the number of tissue samples, and therefore the number of genes times greater than the minimum requirement of the data sets necessary.

Since the parameter estimation can finally be reduced to solving a small linear equation system, a much higher stability can advantageously be expected than with a direct estimate of all components of the matrix A.

The change in the activity of a component i can be expressed in the form of the correlation coefficients of component pairs and the respective standard deviation according to the following Equation (II).

$${x}_{i} = {σ}_{i} {\sum }_{j} {u}_{j} {σ}_{j} cor ( {ξ}_{i} , {ξ}_{j} ) \qquad ( II )$$

where:
xᵢ is the shift in the activity of the i^{th} component as a reaction to the perturbation,
σᵢ is the standard deviation of the component i in a “stratified” system,
cor (ξᵢ, ξⱼ) is the linear correlation coefficient between the changes in the activity of the components i and j in the stratified system,
uⱼ is the perturbation, which acts on the component j.

The term “stratified”, in the sense of the calculations of the method according to the invention, has the meaning that the average value of the activity before and after the exerted perturbation is calculated for each component. Then, for each component and each value of the activity, the respective average value is subtracted. In preferred embodiments of the method the term “stratified”, in the sense of the calculations of the method according to the invention, has the meaning that the average value of the expression for each particular gene is calculated for each applied pharmaceutical active agent, or averaged over an applied substance group comprising a plurality of equivalent active agents. For each gene and each expression value, the respective average value then is subtracted. The effect achieved by this is that only the fluctuations around the steady state, respectively described by the average values, are now taken into account.

By using |u|=(Σuₖ²)^{1/2}, where, for each component, k represent coefficients that represent the effect of the perturbation on the component, the “effective perturbation” for the entire perturbation can be reformulated by the following Equation (III)

$${ξ}_{u} = \frac{{\sum }_{j} {u}_{j} {ξ}_{j}}{\vert u \vert} \qquad ( III )$$

where:
ξᵤ is the formal vector of the activity change for a fictitious component, which represents the point of action of the perturbation and is calculated by weighted averaging over the x values of the components involved,
Σⱼuⱼξⱼ describes the calculation of the weighted average value of the activities of the components, which are influenced directly by the perturbation or the stress,
   |u| reflects the intensity of the perturbation or the stress.

The term |u| is in this case identical to 1/μ in Equation (S9) of the formal derivation.

In preferred embodiments of the method, the data of the activity change for a fictitious component, which represents the point of action of the perturbation, are expression values for the gene expression.

This reformulation of the perturbation allows the sum of the effect of a component j on the change in the activity of a component i, caused by the perturbation, to be expressed by the following Equation (IV):

xᵢ=|u|σᵢσᵤcor(ξᵢ,ξᵤ) (IV)

where:
xᵢ is the shift in the activity of the i^{th} component as a reaction to the perturbation or the stress,
   |u| is the intensity of the perturbation,
σᵤ is the standard deviation of the response generated by the noise u,
σᵢ is the standard deviation of the component i,
cor (ξᵢ, ξᵤ) is the linear correlation coefficient between the changes in the activity of the components i and j in the stratified system.

Here, σᵤ corresponds to |ξᵤ| in Equation (S9).

Equivalently, Equation (IV) may be expressed by the following algebraic Equation (V):

$$\frac{{x}_{i}}{{σ}_{i}} = \vert u \vert {σ}_{u} cor ( {ξ}_{i} , {ξ}_{u} ) = r cor ( {ξ}_{i} , {ξ}_{u} ) \qquad ( V )$$

where
r is the gradient.

Equations (IV) and (V) describe the change in the activity of the components due to a reversible perturbation, the calculation being carried out using the strength of the perturbation |u|, the standard deviation σᵢ of the ξᵢ of the component i and a vector ξᵤ and σᵤ, which reflects the effective perturbation on the components.

Equations (IV) and (V) are no longer dependent on an actual component i, so that for calculating the behavior of the biological multipurpose it is sufficient to determine a vector σᵤξᵤ and a number for |u| as an “effective strength of the perturbations”. This determination is possible using the data determined for the change in the activity of the components of the network, where |u| per se is not measurable and the quantity which is entered into the model is r=|u|σᵤ, where r can be determined by linear regression from Equation (V) with the aid of the measurement data.

The method provided therefore makes it possible to calculate the behavior of a biological network due to a reversible perturbation with the aid of the linear model which is provided, from the data determined for the change in the activity of the components as a reaction to a reversible perturbation.

The gradient r=|u|σᵤ provides a measure of the sensitivity of the change in the activity of the components, with a reference to the formal distance from the component i to the place of action of the stress expressed by the correlation coefficient cor (ξᵢ, ξᵤ). Presupposing a network of the components with a purely linear interaction of the components with one another, and without a spread, the gradient r should be constant for all components.

Equations (IV) or (V) reveal that the vector ξᵢ for components with high values of the parameter xᵢ/σᵢ should be highly correlated with the vector ξᵤ. The vector ξᵤ is the remaining quantity, not measurable from determination of the activity change of the components. Although ξᵤ is unknown, it is found that the vector ξᵢ for groups of components with similar values of xᵢ/σᵢ is oriented in an “angle” around ξᵤ, the cosine of the conic angle being given by the parameter cor (ξᵢ, ξᵤ). The parameter ξᵤ is unknown, since the vector ξᵢ of the individual components has a different correlation with the vector ξᵤ.

Determining the activity of the components reveals the change in the activity for each component i and therefore the parameter xᵢ, as well as the standard deviation σᵢ of the component i.

The standard deviation σᵢ is determined from a plurality of measurements when compiling the model. To this end preferably at least two biological systems, preferably at least three, preferentially at least four biological systems, preferably selected from the group comprising cell, cell culture, tissue, organ and/or organism, are provided and the method is carried out, in particular steps (a) to (g) on the systems provided. From the obtained measurement data of the change in the activity of the components, for example the change in the gene expression, after the reversible perturbation used, the standard deviation σᵢ can then be calculated for the component i.

A particular advantage in this case is that the standard deviation σᵢ for the component i is determined, with the aid of the perturbation used, in a system and is subsequently usable when applying the model for other perturbations of the system.

Another advantage in this case is that once it has been determined, the standard deviation σᵢ for the component i allows the method according to the invention to be used for another perturbation of the component i in the system being used, without σᵢ needing to be determined again. Advantageously, the behavior of a network comprising components of known standard deviation σ can be determined from the activity of the biological or biochemical components of the biological network as determined in steps (c) and (e), before and after exerting the reversible perturbation.

The vector ξᵢ is thus found for all components i, and Equation (V) makes it possible to calculate σᵤ ξᵤ. This calculation can be carried out by means of optimization methods. Suitable optimization methods are for example all methods of combinatorial optimization, preferably selected from the group comprising genetic algorithms and/or simulated annealing. Suitable genetic algorithms are described for example in Ingo Rechenberg, Evolutionsstrategie '94, Frommann Holzboog, 1994.

The calculation of ξᵤ may in particular be calculated by presupposing that |u| as well as ξᵤ are approximately constant in a biological system.

Reconstruction of ξᵤ from the data of the determined change in the activity of the components presupposes that Equation (V) is converted into an overdetermined linear equation system.

ξᵤ is preferably determined by combinatorial optimization, a preferred algorithm being the so-called genetic algorithm. This is described for example in Ingo Rechenberg, Evolutionsstrategie ∝94, Frommann Holzboog, 1994. Other suitable optimization methods, which make it possible to calculate ξᵤ from the data determined for the change in the activity of the components, are for example selected from the group comprising so-called simulated annealing and/or the so-called grand deluge algorithm.

ξᵤ is preferably determined in the form of a linear combination from the data determined for the change in the activity of the components for a selected number of components. The number of components, which are used for such determination, may preferably lie in the range of from 1 to 4000 components, preferably in the range of from 5 to 100 components.

From the number of components, a suitable subgroup of components, for example named Sᵤ, for example with a number of components in the range of ≧10 components to ≦4000 components, preferably in the range of from ≧20 components to ≦200 components, may be used in order to calculate the statistical weighting wᵢ for a linear combination according to the following Equation (VI):

$${ξ}_{u}^{′} = {\sum }_{i ∈ {S}_{u}} {w}_{i} {ξ}_{i} \qquad ( VI )$$

where:
ξᵤ′ is the optimized formal vector of the biological noise for a fictitious component, which represents the point of action of the perturbation,
wᵢ is the statistical weighting of the components,
ξᵢ is the vector of the shift of the i^{th} component as a reaction to the noise around the average value of the activity of the component i, for example the expression of gene i, in the stratified system.

The calculated weighting wᵢ makes it possible to calculate the linear correlation coefficients of Equation (V), as well as those of the other parameters of the equation. The values obtained may then be used to determine the genetic algorithms and an optimal number of components for the optimization of ξᵤ. This optimization is preferably part of the optimization method which may be used.

By using the optimized ξᵤ′, Equation (V) or (IV) can be calculated for all the components.

The method according to the invention therefore allows the behavior of a biological network to be calculated with the aid of experimentally available data of the change in the activity of the individual components of the network. A particular advantage in this case is that such calculation is made possible even with a very large number of components with the aid of the linear model provided for describing the behavior of the network; taking into account the biodiversity of the reaction of the components allows calculation without a matrix, which contains the parameters that described the reaction of the components to a perturbation, having to be calculated explicitly within the linear model which is provided.

In preferred embodiments of the method according to the invention, the biodiversity is a biological variation selected from the group comprising natural variation of an activity of a component or of a network, a natural variation of a biological system and/or a variation of the biological reactions of a system to environmental factors, which makes it possible to determine the model provided with the aid of the variations generated by the biodiversity without systematic experiments.

This provides a particular advantage of the method according to the invention, with which the behavior of a network of many components or a large number of genes, such as may for example be regulated as a reaction to a toxic stress, can be determined without systematic experiments having to be carried out.

In particular the method according to the invention makes it possible, by providing a biological system, exerting a perturbation on the system and determining the change in the activity of the components once, for the behavior to be described with the aid of the linear model which is provided.

A perturbation may, for example, be a stress which acts on the system. The perturbation is preferably an external stress, preferentially selected from the group comprising toxic stress, preferably selected from the group comprising stress due to non-genotoxic or genotoxic hepatocarcinogens, heat stress, stress due to hunger, stress due to application of a pharmaceutical active agent, a chemical and/or a medicament.

Preferred biological systems are selected from the group comprising cell(s), tissue, organ(s) and/or organism, preferred tissues or organs being those which contain biological and/or biochemical components. Preferred tissues or organs are selected for example from the group comprising brain and/or liver. It is to be understood that every biological system may be used in the scope of the present invention, for example prokaryotic and eukaryotic cells or organisms. A biological system may for example be a cell culture or a mammalian organism such as a mouse or rat, which may be exposed to a reversible perturbation by suitable experimental conduct.

Preferred biological components are genes. In particular, the study of gene expression is the subject of extensive studies into the reaction of biological systems to a perturbation or stress. Preferred biochemical components are selected from the group comprising RNA, DNA, metabolites and/or proteins.

Biological and/or chemical components may react to a reversible perturbation by changing their activity. Depending on the type of the stress and the components thereby influenced and/or the strength of the perturbation exerted, different biological and/or biochemical components are affected by such a perturbation. Depending on the type and extent of the perturbation, many or few components of a network may be affected by such a perturbation. The number of components which are directly affected can vary within wide ranges, for example in a range of from ≧1 component to all the components, corresponding to ≦100% of the components, preferentially in the range of up to ≦20% of the components, more preferentially in the range of up to ≦10% of the components, preferably in the range of up to 5% of the components, also preferentially in the range of up to ≦3% of the components, more preferably in the range of up to ≦2% of the components.

In further preferred embodiments of the method according to the invention, a perturbation can be calculated based on the change in the activity of all the components so long as their activity, preferably their expression, can be measured accurately enough. The sufficiently accurately determinable number of components, for example in gene expression networks, lies in the range of up to 40% of the components, preferably in the range of up to 30% of the components. It is a particular advantage of the method according to the invention that rough calculation of the behavior of a network is still made possible when more than 30% of the components of a network are affected by the reversible perturbation, in particular when more than 40% of the components of a network are affected.

The activity of the biological or biochemical components of the network may likewise be affected to a varying extent as a function of the reversible perturbation. In preferred embodiments of the method according to the invention, the activity of the components is affected in a range of from 0.1% to 30%, preferentially from 0.5 per cent to 25%, preferably from 1% to 20%, more preferentially from 5% to 15% expressed in terms of the activity of the biological or biochemical components in the basic state, i.e. in a state before a perturbation is exerted on the system or when no perturbation is exerted on the system.

The method according to the invention in preferred embodiments is a method in the field of quantitative toxicogenomics. In preferred embodiments, the biochemical or biological components are correspondingly genes and RNA and/or DNA molecules. In the scope of the present invention, change in the activity of a gene preferably means that such a gene is regulated up or down in its expression. The expression rate of a gene is preferably determinable as the content of the RNA or the corresponding gene product. In particularly preferred embodiments, the RNA content present in the corresponding system, preferably a cell culture or cells of a tissue, is determined.

The change in the activity of at least one biological or biochemical component is correspondingly preferably determined by means of methods which can provide information about the RNA or DNA content present in a system here, preferably from the group comprising semiquantitative RT-PCR, Northern hybridization, differential display, subtractive hybridization, subtracted libraries, cDNA arrays and/or oligo-arrays.

In other preferred embodiments of the method according to the invention, the biochemical component may be a protein, or a metabolite of an active substance which has been administered as a perturbation.

It may correspondingly be furthermore preferable for the change in the activity of a component to be determined by means of methods which are selected from the group comprising methods that can be used to determine a protein content of a system, preferably selected from the group comprising Western hybridization, ELISA technique (Enzyme Linked Immuno Sorbent Assay) and/or spectroscopic methods, for example HPLC (High Pressure Liquid Chromatography), fluorescence-based absorptive or mass-spectrometric detection.

In preferred embodiments of the method according to the invention, comparison may be made between the change in the activity of the individual components as determined according to stepped (f) and the behavior of the biological network as calculated according to step (g) with the aid of the linear model which is provided, there being expected to be a match of the calculated behavior with the change in the activity of the biological or biochemical components as determined in step (f). If such a comparison reveals that there is a match between the determined change in the activity of a component and the corresponding calculation by the model which is provided, i.e. there is correspondingly a match of preferably experimentally determined data and the calculation of the model, the experimentally determined reaction of the component to the perturbation is subject to the prediction of the model.

In other embodiments of the method according to the invention, with such a comparison according to step (h) of the method, it may be possible to establish that there is a statistically significant deviation of one or more components(s) in the change in the activity as determined according to step (f) and the behavior of the components(s) in the network as calculated according to step (g), which shows that these components(s) are not subject to the linear model which is provided. Such a component, which is not subject to the linear model provided, may be an indicator of a perturbation-induced transition into a new state of the component and show such a transition. Such a deviation from the behavior calculated by the linear model which is provided may, in particular, mean that the perturbation is irreversible for the component. In the event of an irreversible perturbation, the system does not return into its initial state after the stress is removed, and/or an individual component does not return into the initial state of the activity before the reversible perturbation, after the perturbation is removed. Such a component may serve as an indicator that the system has changed over into another state of the biological system, for example into a state which corresponds to a disease caused by the perturbation.

An advantage of the method according to the invention is that an establishable statistically significant deviation of one or more components allows inference about whether the system comprises one or more components which can show that the system does not react reversibly after the exerted perturbation, but instead adopts a state differing therefrom, preferably a state which characterizes a disease of the system.

In a preferred embodiment of the method according to the invention, the statistical significance is determined by means of a significance test preferably selected from the group comprising T-test, Z-test and/or chi-square test.

In other embodiments of the method, in a further step it may be found that there is a statistically significant regulation of the activity of one or more components(s) according to the change in the activity as determined in step (f) and the behavior of the component in the network as calculated according to step (g).

The distance from a direct point of action of the perturbation may be obtained by the correlation coefficient cor (ξᵢ, ξᵤ). The greater the absolute quantity is, the closer the component is to the point of action.

Such a statistically significant isolation of the activity of one or more components may mean that this component lies close to the mechanistic point of action of the perturbation. Such a component, which is regulated significantly more strongly in its activity by the exerted perturbation, has a high sensitivity to the perturbation. Such a significantly regulated component may be a component, for example a gene, which forms a biomarker with a corresponding calculation method for calculating a quantity which is not directly observable, for example physiological changes of an organism.

In another preferred embodiment of the method, it may be used for the determination of biomarkers.

In another preferred embodiment of the method, steps (a) to (h) may be repeated for at least two reversible perturbations and optionally at least two systems, and in a further step of the comparison it is found that there is a statistically significant regulation of the activity of one or more component(s) according to the change in the activity as determined in step (f) and the behavior of the component as calculated according to step (g) in relation to different types of perturbations, which allows classification of the perturbation with the aid of the occurrence of the statistically significant regulation of the component(s).

Preferably, it is possible to establish that at least one of the particular components has a statistically significant regulation in relation to a particular type perturbation, and has regulations statistically significantly different therefrom in relation to other types of perturbations, so that a statistically significant characteristic reaction to a particular perturbation may be established. Such statistically significant regulation of at least one component, due to a particular perturbation, makes it possible to classify the perturbation with the aid of the occurrence of such a component referred to as a biomarker. In preferred embodiments of the method, the obtaining of such a biomarker may be provided by determining the change in the activity of at least one component and calculating the behavior of the network to which this component belongs, according to the linear model which is provided.

In preferred embodiments, statistically significant regulation of the activity of a plurality of components is found, in which case such regulation may be positive or negative regulation, for example regulating the gene expression up or down in relation to the expression rate of genes. The statistically significant regulation of a plurality of components is not necessarily in the same direction; rather, it may preferably correspond to a characteristic pattern of the regulation of the different components.

Advantageously, in preferred embodiments, the method according to the invention allows a large number of components to be calculable by the model. In further advantageous embodiments of the method, the method furthermore allows the calculation to be restrictable to as few components as possible. The method according to the invention preferably makes this possible in that statistically significant regulation of the activity of one or more components and the calculated change in the behavior of the network makes it possible for the significantly regulated components, through their significant regulation by a particular perturbation, allow this perturbation to be classified for example in further or repeated methods.

In preferred embodiments, the method according to the invention is a method in the field of quantitative toxicogenomics. In preferred embodiments of the method, the components are genes and the gene expression preferably of stress genes is determined. The system is preferably a mammal, for example a rat or mouse, which comprises different tissues for example selected from the group comprising liver and brain, or a cell culture. And external perturbation is preferably exerted by exerting a reversible toxic stress on the system. Preferentially at least one pharmaceutical active agent, preferably a plurality of pharmaceutical active agents, preferably at least one carcinogen is applied. In a plurality of systems which are provided, a plurality of pharmaceutical active agents or other chemicals, preferably carcinogens, preferentially selected from the group comprising active agents which exert a non-genotoxic stress, genotoxic stress and/or hepatotoxic stress, may be applied.

In a particularly preferred embodiment of the method, the method relates to determination of the change in the gene expression in a tissue after a reversible toxic stress, comprising the following steps:
(a) providing an organism, which contains a tissue that comprises a biological network comprising a multiplicity of genes;
(b) providing a linear model for describing the change in the gene expression of the network;
(c) determining the basic gene expression of the genes;
(d) exerting a toxic stress, preferentially application of a pharmaceutical active agent, preferably a carcinogen, a change in the gene expression being generated;
(e) determining the gene expression after application of the toxic stress, preferentially the pharmaceutical active agent, preferably the carcinogen, as soon as the genes of the network have completed the reaction to the stress;
(f) determining the change in the expression of at least one machine after exerting the toxic stress, preferentially application of the pharmaceutical active agent, preferably the carcinogen;
(g) calculating the change in the gene expression level genes of the network with the aid of the linear model provided for describing the behavior of the biological network from the determined change in the expression of at least one gene while taking into account the biodiversity of the change in the gene expression; and
(h) optionally comparing the change in the expression of at least one gene as determined according to step (f) and the change in the gene expression of the genes of the network calculated according to step (g) with the aid of the linear model which is provided, there being expected to be a match of the calculated change in the gene expression with the change in the expression of at least one gene as determined in step (f).

In preferred embodiments of the method, the carcinogen is selected from the group comprising non-genotoxic, genotoxic and/or hepatotoxic carcinogen.

According to preferred embodiments of the method, the expression of a number of genes in the range of from ≧1 gene to ≦25,000 genes, preferably in the range of from ≧1 gene to ≦15,000 genes, preferentially in the range of from ≧1 gene to ≦5000 genes, particularly preferentially in the range of from ≧2 genes to ≦1000 genes, more preferably in the range of from ≧5 genes to ≦400 genes, even more preferably in the range of from ≧5 genes to ≦200 genes is determined.

Another subject of the present invention relates to a computer program product having computer-readable means for carrying out one or more steps of the method, when the program is run on a computer. The invention may advantageously be carried out in one or more computer programs for execution in a computer system, having software components for carrying out one or more steps of the method, when the program is run on a computer. Another subject of the present invention therefore relates to a computer program for execution in a computer system, having software components for carrying out one or more steps of the method, when the program is run on a computer. Another subject of the method relates to a computer system having means for carrying out the one or more steps of the method according to the invention.

Unless otherwise indicated, the technical and scientific expressions used have the meaning which is commonly understood by an average person skilled in the field to which this invention belongs.

All publications, patent applications, patents and other literature references indicated here have their content fully incorporated by reference.

Examples, which serve to illustrate the present invention, will be given below.

Calculations and data analyses were carried out by using Matlab, Mathworks, Waltham, USA, unless otherwise indicated.

### EXAMPLE 1

Determination of the Gene Expression in Rat Liver after a Reversible Toxic Stress

The conduct of the test, the treatment conditions and the sample preparation were carried out as described in “Ellinger-Ziegelbauer et al., Mutation Research 575, 2005 S. 61-84”, unless otherwise indicated below.

For the in-vivo studies, male Wistar Hanover rats (Crl:WI[Gl/BRL/Han]IGS BR, Charles River Laboratories Inc, Raleigh, USA) were divided into test groups of 5 animals each and respectively received one of the following substances in the concentration indicated once per day for a period of 1, 3, 7 or 14 days by stomach tube (gavage). Five genotoxic carcinogens were used: 2-nitrofluorene (Sigma, St. Louis, USA), at a concentration of 4 mg/kg/day for 3 and 7 days, dimethylnitrosamine (Sigma, St. Louis, USA), at a concentration of 4 mg/kg/day for 3 and 7 days, aflatoxin B1 (Sigma, St. Louis, USA), at a concentration of 0.24 mg/kg/day for 3 and 7 days, N-nitrosomorpholine (TCI America, Portland, USA), at a concentration of 3.5 mg/kg/day for 3 and 7 days, and CI Direct Black (TCI America, Portland, USA), 146 mg/kg/day for 3 and 7 days; five non-genotoxic carcinogens: methapyrilene HCl (Sigma, St. Louis, USA), at a concentration of 60 mg/kg/day) for 3 and 7 days, thioacetamide (Sigma, St. Louis, USA), at a concentration of 19.2 mg/kg/day for 3 and 7 days, diethylstilbestrol (Sigma, St. Louis, USA), at a concentration of 10 mg/kg/day for 1 and 3 days, Wy 14643 (TCI America, Portland, USA), at a concentration of 60 mg/kg/day for 1 and 3 days, and piperonyl butoxide (Sigma, St. Louis, USA), at a concentration of 1200 mg/kg/day for 1 and 3 days; and three additional non-hepatotoxic substances: cefuroxims (Sigma, St. Louis, USA), at a concentration of 250 mg/kg/day for 1, 3, 7 and 14 days, nifedipine (Sigma, St. Louis, USA), at a concentration of 3 mg/kg/day for 1, 3, 7 and 14 days, and propranolol (Sigma, St. Louis, USA), at a concentration of 40 mg/kg/day for 1, 3, 7 and 14 days.

The dosing of the carcinogens was selected so that a liver tumor occurs only under the condition of long-term administration, so that short-term administration of these carcinogens in a range of 14 days merely exerts a reversible toxic stress on the rats. For each administration group, solvent was applied in the same way to a corresponding group of controls.

After the days of application indicated for each substance, the total RNA of the livers of 3 equally treated test animals was respectively isolated by means of RNAeasy 96 well kits (Qiagen). The analysis of the RNA expression was carried out with the Affymetrix Gene Chip Microarray Platform (Affymetrix Inc., Santa Clara, USA) according to a standard protocol (“GeneChip Sample Cleanup Module, Section 2: Eukaryotic Target Preparation, Affymetrix 701194 Rev.1, 2002). The individual steps are described briefly below. 5 μg of the total RNA were transcribed as specified with the cDNA Double-Stranded Synthesis Kit, (Life Technologies, Karlsruhe) into double-stranded cDNA. From the purified cDNA, biotinylated copy-RNA (cRNA) was subsequently produced in an in vitro transcription reaction with the ENZO Bio Array high Yield RNA transcript Labeling Kit, (Affymetrix Inc., Santa Clara, USA). After fragmentation, 15 μg of the biotinylated cRNA were hybridized with RAE230A Microarrays (Affymetrix Inc., Santa Clara, USA).

After hybridization for 16 hours, the arrays were washed according to the manufacturer's specifications and dyed with phycoerythrin-marked streptavidin (Molecular Probes, Eugene, USA). The phycoerythrin fluorescent was subsequently read in an Agilent Gene Array Scanner (Agilent, Palo Alto, USA).

The RAE230A Microarray represents 15,866 so-called “probe sets”. These correspond to 14,280 rat-specific UniGene clusters, which in turn for the most part correspond to individual rat genes. The raw data files (DAT) output by the scanner were converted into CEL files with the aid of the Microarray Suite 5.0 (MAS5) software from Affymetrix by background correction and averaging the fluorescence values of all 36 pixels per oligonucleotide set. This was followed by quality control of the microarrays with the Expressionist software from Genedata AG (Basel, Switzerland). This can recognize and correct fluorescence gradients and light or dark spots for each microarray. In the CEL files, a probe set is represented by 11 pairs of perfect match (PM) and mismatch (MM) oligonucleotide sets, one nucleotide in the middle being replaced in the MM oligonucleotides so that it can no longer hybridize with the matching cRNA of the gene represented by the PM, and therefore represents a measure of unspecific background hybridization.

The intensity values of the individual PMs and MMs for each probe set were then computed by two different algorithms to give an intensity value. These algorithms, called MAS5 and GCRMA, lead to somewhat different intensity values in the low expression range. The two sets of data files resulting therefrom, with one intensity value per probe set, were then used as described in the following example.

Overall, microarrays of 138 liver tissue samples were hybridized, the samples having been divided into groups corresponding to liver samples of animals to which genotoxic carcinogens (Group 1), non-genotoxic carcinogens (Group 2) and non-hepatotoxic carcinogens (Group 3) were applied, and the respective controls of the gene expression before application of the carcinogen (Group 0).

### EXAMPLE 2

Calculation of the Change in the Gene Expression with the aid of the Linear Model

For compiling the model, the 4000 most highly expressing genes determined by means of Affymetrix according to Example 1 were used. The selection was carried out by calculating the average expression of each gene and then selecting the 4000 genes with the highest average expression. The selection was carried out in order to avoid errors in the evaluation of expression data at low expression values.

For each of the 4000 genes i, the logarithmic expression rate xᵢ was calculated individually.

To this end, for all data which are obtained with the aid of GCRMA from the raw measurement data, the natural logarithm is calculated with the aid of Matlab.

Data obtained for each gene were furthermore stratified. To this end, for each gene, the average value of the expression for each substance group was calculated. Next, for each gene and each expression value, the respective average value was subtracted. The effect achieved by this is that only the fluctuations around the steady state respectively described by the average values were then taken into account.

For determining the respective steady state, the average value over each substance group 0, 1, 2 and 3 was calculated for each gene.

By means of this, for each gene i, a value xᵢ is obtained which reflects the average shift in the gene expression of the i^{th} component as a reaction to the toxic stress. In addition, for each gene i and each tissue sample, the stratified expression value ξᵢ was calculated by subtracting, from all expression values of the gene i in the tissues of the stress group, the average value of the expression of the gene i in this tissue group. These values give the noise around the average value of the respective group of each substance group 0, 1, 2 and 3. This noise is generated on the one hand by measurement errors, and on the other hand by the biodiversity of the reaction of the genes to the respective toxic stress, and additional stochastically fluctuating environmental conditions.

From the values ξᵢ, the standard deviations σᵢ over the 138 samples used were calculated for each gene with the aid of Matlab.

From known values of the average shift xᵢ and σᵢ, the term xᵢ/σᵢ was calculated for the genes. This term gives the effective shift in the gene expression of the individual genes due to the perturbation.

From the obtained values of xᵢ/σᵢ for the 4000 genes, the 100 most significant genes with the highest values of xᵢ/σᵢ were selected.

For these 100 no significant genes, the weights wᵢ were calculated by optimization with the aid of a genetic algorithm. This procedure will be described below. From these weights, ξᵤ was calculated according to

$${ξ}_{u} = {\sum }_{i} {w}_{i} {ξ}_{i}$$

and the pairwise correlation coefficient cor (ξᵢ, ξᵤ) was then calculated according to Equation (IV) with the known ξᵢ.

Table 1 below gives the values of xᵢ/σᵢ and cor (ξᵢ, ξᵤ) by way of example for the 100 most highly expressed genes:

| | xᵢ/σᵢ for the 100 | cor (ξᵢ, ξᵤ) for the |
|---|---|---|
| Gene | most highly | 100 most highly |
| Number | expressing genes | expressing genes |
| 1 | −0.8639 | −0.2284 |
| 2 | −1.7449 | −0.2937 |
| 3 | −0.3352 | −0.1256 |
| 4 | −1.714 | −0.1832 |
| 5 | −0.1267 | 0.054 |
| 6 | −1.1887 | −0.1871 |
| 7 | −0.5797 | −0.0272 |
| 8 | −1.1887 | −0.1375 |
| 9 | −0.9122 | −0.0954 |
| 10 | −0.7818 | −0.1221 |
| 11 | 1.0403 | 0.1477 |
| 12 | −0.621 | −0.005 |
| 13 | −1.0258 | −0.1489 |
| 14 | −2.0452 | −0.2533 |
| 15 | −1.5043 | −0.0387 |
| 16 | −1.8747 | −0.2316 |
| 17 | 1.2427 | 0.0753 |
| 18 | −1.1158 | −0.2487 |
| 19 | −0.0269 | 0.0349 |
| 20 | −1.5387 | −0.2411 |
| 21 | −0.5044 | 0 |
| 22 | 1.4232 | 0.1759 |
| 23 | −1.2783 | −0.1777 |
| 24 | −2.0932 | −0.3754 |
| 25 | −1.9516 | −0.261 |
| 26 | −0.8018 | −0.1673 |
| 27 | −1.5668 | −0.2338 |
| 28 | −2.731 | −0.2212 |
| 29 | −2.8363 | −0.3401 |
| 30 | −1.0813 | 0.0704 |
| 31 | 0.0119 | −0.0596 |
| 32 | 0.964 | 0.1351 |
| 33 | −1.1782 | −0.0393 |
| 34 | −1.6021 | −0.17 |
| 35 | −0.9161 | −0.1772 |
| 36 | −1.6307 | −0.3445 |
| 37 | −0.634 | −0.0916 |
| 38 | −0.1102 | −0.0148 |
| 39 | −0.1269 | 0.0543 |
| 40 | −1.9546 | −0.3756 |
| 41 | −0.3329 | 0.0894 |
| 42 | 0.1357 | −0.1004 |
| 43 | −0.33 | 0.1339 |
| 44 | −0.5336 | −0.012 |
| 45 | −0.0215 | −0.0694 |
| 46 | 0.5651 | 0.1144 |
| 47 | −0.456 | −0.0907 |
| 48 | −1.5579 | −0.2523 |
| 49 | −1.406 | −0.2453 |
| 50 | −1.6404 | −0.2383 |
| 51 | −1.6086 | −0.1596 |
| 52 | −0.8255 | −0.2469 |
| 53 | −1.2481 | −0.1669 |
| 54 | −1.7704 | −0.2794 |
| 55 | −0.8749 | −0.1012 |
| 56 | 1.1776 | 0.204 |
| 57 | −1.4196 | −0.2213 |
| 58 | −1.5482 | −0.1247 |
| 59 | −1.2607 | −0.1632 |
| 60 | −1.661 | −0.249 |
| 61 | −3.182 | −0.4786 |
| 62 | −0.5108 | −0.1255 |
| 63 | 0.3719 | 0.092 |
| 64 | 1.6891 | 0.2705 |
| 65 | −0.7853 | −0.1772 |
| 66 | −0.0616 | 0.0251 |
| 67 | −1.6085 | −0.2457 |
| 68 | −1.1772 | −0.228 |
| 69 | −1.8573 | −0.202 |
| 70 | 1.4588 | 0.2035 |
| 71 | −0.1823 | 0.0684 |
| 72 | 0.2329 | 0.1671 |
| 73 | 1.3752 | 0.1567 |
| 74 | −1.3919 | −0.2328 |
| 75 | −2.486 | −0.3218 |
| 76 | −1.616 | −0.2251 |
| 77 | −1.616 | −0.2251 |
| 78 | −0.1054 | −0.0522 |
| 79 | 1.1247 | 0.1754 |
| 80 | −0.8774 | −0.1094 |
| 81 | −0.0144 | 0.0008 |
| 82 | −1.709 | −0.0839 |
| 83 | −1.8448 | −0.2745 |
| 84 | −2.8029 | −0.2393 |
| 85 | 1.712 | 0.3029 |
| 86 | 0.8732 | 0.1756 |
| 87 | −2.7089 | −0.251 |
| 88 | −1.7333 | −0.2831 |
| 89 | −0.9931 | −0.0826 |
| 90 | −0.9297 | −0.0934 |
| 91 | 0.8024 | 0.1281 |
| 92 | 0.8872 | 0.066 |
| 93 | −1.0377 | −0.1278 |
| 94 | −0.3729 | −0.1597 |
| 95 | −0.5099 | −0.062 |
| 96 | 1.3229 | 0.1239 |
| 97 | −2.1548 | −0.2142 |
| 98 | −2.1819 | −0.3201 |
| 99 | −0.3307 | −0.032 |
| 100 | 2.9326 | 0.4455 |

The calculation of ξᵤ was carried out as follows:

The calculations were carried out with the aid of the 4000 most highly expressing genes, the 100 most significant genes respectively being used as a training data set for calculating the parameters, and the remaining 3900 genes as a test data set for testing the model quality with the parameters obtained.

In order to improve the stability of the model, only a portion of about 30 genes from these 100 genes were used for the modeling. In order to determine this portion optimally, the vector ξᵤ was optimized using the genetic algorithm by selecting this subset of genes stepwise with the aid of the genetic algorithm so that the model had a minimal error.

The optimal selection of this gene group was carried out with the aid of a genetic algorithm as described in the literature. To this end 20 gene groups were formed with 20 genes each. For each gene group, the weight wᵢ was then calculated by solving Equation (V) after substituting Equation (VI) with the aid of the linear algebra routines of Matlab by using the 100 most significant genes. Then the prediction values for the other 4000 genes were calculated for each gene group with the calculated weights wᵢ determined according to Equation (VI) and with the aid of Equation (V) and the aforementioned formula for ξᵤ. The mean square error of the deviation of these prediction values from the measured values gave the measure of the quality of the model, which is determined by each gene group. As is conventional with genetic algorithms, the 20 gene groups were then varied by recombination and mutation and the calculation of the model parameters and the respective model quality was carried out again with the varied gene groups. This procedure was repeated until no further improvement could be achieved. No further significant improvement in the prognosis ability of the model was achieved after 200 repetitions.

This optimized vector ξᵤ was then used in order to calculate the change in the gene expression of all genes of the network according to Equation (IV).

Table 2 below gives the values of ξᵤ, which was obtained as a result of the optimization, for the 138 tissue samples used:

| Tissue | |
|---|---|
| Number | Vector ξᵤ |
| 1 | 76.5569 |
| 2 | −14.5742 |
| 3 | 288.1599 |
| 4 | 11.1768 |
| 5 | 230.3513 |
| 6 | 191.2853 |
| 7 | 188.1156 |
| 8 | 291.1027 |
| 9 | 224.6252 |
| 10 | −53.294 |
| 11 | −90.4583 |
| 12 | −294.7351 |
| 13 | 274.2629 |
| 14 | −56.5562 |
| 15 | −28.1301 |
| 16 | 167.6595 |
| 17 | −137.847 |
| 18 | −77.9698 |
| 19 | −54.7617 |
| 20 | −169.1818 |
| 21 | −5.0533 |
| 22 | 15.2488 |
| 23 | −82.9799 |
| 24 | −73.3627 |
| 25 | −268.3438 |
| 26 | −27.8142 |
| 27 | −31.3407 |
| 28 | −234.3951 |
| 29 | 208.0049 |
| 30 | 98.5644 |
| 31 | −17.0821 |
| 32 | 3.8032 |
| 33 | −1.7166 |
| 34 | 13.7851 |
| 35 | 36.9275 |
| 36 | −275.6066 |
| 37 | 83.9284 |
| 38 | −7.4295 |
| 39 | −43.6217 |
| 40 | 77.6214 |
| 41 | −36.2371 |
| 42 | 30.5607 |
| 43 | 0.5632 |
| 44 | −99.5823 |
| 45 | −33.3024 |
| 46 | 18.2819 |
| 47 | 36.0453 |
| 48 | −14.2015 |
| 49 | 145.4589 |
| 50 | −160.644 |
| 51 | 77.3361 |
| 52 | 48.4672 |
| 53 | −40.5311 |
| 54 | −74.2292 |
| 55 | 47.0955 |
| 56 | −50.7783 |
| 57 | −107.2944 |
| 58 | −459.4381 |
| 59 | −581.0783 |
| 60 | 116.1542 |
| 61 | 177.4406 |
| 62 | 149.8353 |
| 63 | 58.9269 |
| 64 | 167.4023 |
| 65 | −59.1586 |
| 66 | −605.2145 |
| 67 | 316.2251 |
| 68 | 322.8739 |
| 69 | −51.0424 |
| 70 | 245.5574 |
| 71 | 66.4274 |
| 72 | 42.202 |
| 73 | −21.7779 |
| 74 | 91.325 |
| 75 | −52.6885 |
| 76 | −57.2132 |
| 77 | −149.6873 |
| 78 | 78.5563 |
| 79 | 448.4771 |
| 80 | −185.6028 |
| 81 | −56.3119 |
| 82 | 113.9029 |
| 83 | 183.2596 |
| 84 | 107.4858 |
| 85 | 128.9119 |
| 86 | 146.4095 |
| 87 | −100.1825 |
| 88 | 83.4926 |
| 89 | 21.8313 |
| 90 | −312.5623 |
| 91 | 78.934 |
| 92 | −75.366 |
| 93 | −18.4466 |
| 94 | −85.8512 |
| 95 | 10.727 |
| 96 | −109.0306 |
| 97 | −43.5056 |
| 98 | 89.0143 |
| 99 | −116.9526 |
| 100 | −102.3417 |
| 101 | −56.6384 |
| 102 | −167.215 |
| 103 | 9.239 |
| 104 | −42.8732 |
| 105 | −68.8991 |
| 106 | −72.9573 |
| 107 | 33.4551 |
| 108 | −30.4143 |
| 109 | −186.0175 |
| 110 | −13.3843 |
| 111 | −25.0929 |
| 112 | −150.191 |
| 113 | −186.7943 |
| 114 | 16.8619 |
| 115 | 79.3224 |
| 116 | 91.981 |
| 117 | −172.7753 |
| 118 | −44.9154 |
| 119 | −46.1011 |
| 120 | 136.5539 |
| 121 | 94.5613 |
| 122 | −121.9597 |
| 123 | −211.345 |
| 124 | −95.7291 |
| 125 | 23.3157 |
| 126 | 50.9724 |
| 127 | 198.6063 |
| 128 | 227.2184 |
| 129 | 101.7276 |
| 130 | 29.5541 |
| 131 | −62.2693 |
| 132 | 119.2673 |
| 133 | −224.152 |
| 134 | 153.3749 |
| 135 | 341.7285 |
| 136 | 126.7139 |
| 137 | −107.1419 |
| 138 | 28.559 |

This optimized vector ξᵤ was then used in order to calculate the change in the gene expression of the 4000 genes of the network according to Equation (IV).

It was found that the change in the gene expression determined with the linear model provided for all genes of the network shows a good match with the measured data. For instance, plotting xᵢ/σᵢ against cor (ξᵢ, ξᵤ) showed that the genes regulated by the reversible perturbation, in particular by the perturbation due to non-genotoxic cancerogens, showed a good match with the linear model.

It was also found that the genes which lay close to the biologically suspected point of action actually had a high coefficient with ξᵤ. Furthermore, it was found that no significant systematic deviations from the model occurred, so that the perturbations caused in the experiment by non-genotoxic cancerogens had no significant nonlinear contributions and could therefore be classified as reversible.

1. A method for determining the behavior of at least one biological system after a reversible perturbation, comprising the following steps:
(a) providing at least one biological system, the biological system comprising a biological network comprising a multiplicity of biological or biochemical components, which have an activity;
(b) providing a linear model for describing the behavior of the network of the biological system;
(c) determining the activity of the biological or biochemical components of the biological network;
(d) reversibly perturbing the activity of at least one of the biological or biochemical components, a reaction of the biological network being generated which is formed by the change in the activity of at least one or more of the biological or biochemical components;
(e) determining the activity of the biological or biochemical components of the biological network after exerting the reversible perturbation, as soon as the components of the network have completed the reaction to the perturbation;
(f) determining the change in the activity of at least one biological or biochemical component of the biological network as a reaction to the reversible perturbation;
(g) calculating the behavior of the biological network with the aid of the linear model provided for describing the behavior of the biological network and the change in the activity of the biological or biochemical component(s) of the biological network after the reversible perturbation as determined in step (f), while taking into account the biodiversity of the reaction of the biological or biochemical component(s); and
(h) optionally comparing the change in the activity of the individual components as determined according to step (f) to the behavior of the biological network as calculated according to step (g) with the aid of the linear model which is provided, there being expected to be a match of the calculated behavior with the change in the activity of the biological or biochemical component(s) as determined in step (f).

2. The method as claimed in claim 1, wherein the linear model which is provided comprises:
a vector, which comprises determination of the change in the activity of at least one biological or biochemical component of the biological network as a reaction to the reversible perturbation,
a matrix, which contains parameters that describe the reactions of the components to the perturbation, and
a vector, which describes the perturbation.

3. The method as claimed in claim 1, wherein the step of calculating the behavior of the biological network involves a matrix, which contains the parameters that describe the reaction of the components to the perturbation, being described by an n×n matrix, where n corresponds to the number of components.

4. The method as claimed in claim 1, wherein the matrix is described by a projection of the data of the change in the activity onto its eigenvectors with the aid of the correlation coefficients of component pairs of the biological network.

5. The method as claimed in claim 1, wherein the vector, which describes the perturbation, comprises a noise contribution that describes the biodiversity of the reaction of the biological or biochemical component(s).

6. The method as claimed in claim 1, wherein the biodiversity is a biological variation selected from the group comprising natural variation of an activity of a component or of a network, a natural variation of a biological system and/or a variation of the biological reactions of a system to environmental factors, which makes it possible to determine the model with the aid of the variations generated by the biodiversity without systematic experiments.

7. The method as claimed in claim 1, wherein the perturbation is a stress selected from the group comprising toxic stresses, stress due to non-genotoxic or genotoxic hepatocarcinogens, heat stress, hunger, stress due to application of a pharmaceutical active agent, a chemical and/or a medicament.

8. The method as claimed in claim 1, wherein the biological system is selected from the group comprising cell(s), tissue, organ(s) and/or organism.

9. The method as claimed in claim 1, wherein the biological component is a gene.

10. The method as claimed in claim 1, wherein the biological component is selected from the group comprising RNA, DNA, metabolite and/or protein.

11. The method as claimed in claim 1, wherein the perturbation causes a direct change in the activity of a number of components of a network in the range of from ≧1 component to all the components, corresponding to ≦100% of the components, expressed in terms of 100% components.

12. The method as claimed in claim 1, wherein in a further step there is found to be a statistically significant regulation of the activity of one or more component(s) according to the change in the activity as determined in step (f) and the behavior of the component in the network as calculated according to step (g).

13. The method as claimed in claim 1, wherein steps (a) to (h) are repeated for at least two reversible perturbations and optionally at least two systems, and in a further step of the comparison there is found to be a statistically significant regulation of the activity of one or more component(s) according to the change in the activity as determined in step (f) and the behavior of the component as calculated according to step (g) in relation to different types of perturbations, which allows classification of the perturbation with the aid of the occurrence of the statistically significant regulation of the component(s).

14. The method as claimed in claim 1, wherein in step (h) it is established that there is a statistically significant deviation of one or more component(s) of the change in the activity as determined according to step (f) and the behavior of the component(s) in the network as calculated according to step (g), which shows that this or these component(s) is/are not subject to the linear model provided.

15. The method as claimed in claim 1, comprising the following steps:
(a) providing an organism, which contains a tissue that comprises a biological network comprising a multiplicity of genes;
(b) providing a linear model for describing the change in the gene expression of the network;
(c) determining the basic gene expression of the genes;
(d) exerting a toxic stress, a change in the gene expression being generated;
(e) determining the gene expression after application of the toxic stress, as soon as the genes of the network have completed the reaction to the stress;
(f) determining the change in the expression of at least one gene after exerting the toxic stress;
(g) calculating the change in the gene expression level genes of the network with the aid of the linear model provided for describing the behavior of the biological network from the determined change in the expression of at least one gene while taking into account the biodiversity of the change in the gene expression; and
(h) optionally comparing the change in the expression of at least one gene as determined according to step (f) and the change in the gene expression of the genes of the network calculated according to step (g) with the aid of the linear model which is provided, there being expected to be a match of the calculated change in the gene expression with the change in the expression of at least one gene as determined in step (f).

16. A method for determining the change of the gene expression in a tissue as claimed in claim 15, wherein the expression of a number of genes in the range of from ≧1 genes to ≦5000 genes.

17. A computer program product having computer-readable means for carrying out one or more steps of the method as claimed in claim 1, when the program is run on a computer.

18. A computer program for execution in a computer system, having software components for carrying out one or more steps of the method as claimed in claim 1, when the program is run on a computer.

19. A computer system having means for carrying out the one or more steps of the method as claimed in claim 1.
